(19) United States
(12) Patent Application Publication
(10) Pub. No.: US 2017/0286008 A1
(43) Pub. Date: Oct. 5, 2017

(54) SMART STORAGE PLATFORM APPARATUS AND METHOD FOR EFFICIENT STORAGE AND REAL-TIME ANALYSIS OF BIG DATA

(71) Applicant: ADVANCED INTITUTES OF CONVERGENCE TECHNOLOGY, Gyeonggi-do (KR)

(72) Inventors: Mi-jeom KIM, Gyeonggi-do (KR); Jung-in CHOI, Seoul (KR)

(73) Assignee: ADVANCED INSTITUTES OF CONVERGENCE TECHNOLOGY, Gyeonggi-do (KR)

(21) Appl. No.: 15/186,230

(22) Filed: Jun. 17, 2016

(30) Foreign Application Priority Data
Mar. 30, 2016 (KR) 10-2016-0038124

(51) Int. Cl. G06F 3/06

(52) U.S. Cl. CPC G06F 3/0647; G06F 3/0604; G06F 3/0683

(57) ABSTRACT

A smart storage platform apparatus and method for efficient storage and real-time analysis of big data, which includes a transformable big data storage module 100, a parallel processing big data analysis module 200, and a big data management API module 300. The smart storage platform apparatus and method can store data in a distributed manner in one or more of a memory, an SSD and an HDD, selected in response to frequency of execution of a specific job, thereby enhancing storage efficiency of large-capacity big data by as much as about 70% compared to conventional systems, retrieve data stored in a distributed manner in the transformable big data storage module, divide the data into blocks, process the data blocks in parallel, and analyze specific data corresponding to a job requested by a client, thereby enhancing a big data analysis speed by as much as about 80% compared to conventional systems and display a result of the job requested by the client through a web interface or directly transmit the result to the client, thereby leading an interactive real-time response type big data platform market in order to solve problems that the number of data nodes configurable per rack is limited and thus: data is randomly stored in memories, SSDs and HDs so as to enlarge a cluster size and increase the number of racks, decreasing a data analysis-speed and problems that, when only SSDs are used, delay is generated in reading and writing operations, wear properties are deteriorated and the number of deletions per block is limited and thus application of only SSDs is restricted in conventional big data systems.

### CROSS-REFERENCE TO RELATED APPLICATION

This application claims priority from Korean Patent Application No, 10-2016-0038124, filed on 30 Mar. 2016, in the Korean intellectual Property Office, the disclosure of which is incorporated herein by reference in its entirety.

### FIELD OF THE INVENTION

The present invention relates to a smart storage platform apparatus and method for efficient storage and real-time analysis of big data, which, can store data in a distributed manner by selecting one or more of a memory, an SSD and m HDD in response to frequency of execution of a specific job on the data.

### DISCUSSION OF RELATED ART

Generally, a big data management system divides data, into blocks each having a specific size, generates a plurality of (for example, three) copies of the data blocks, and distributes and stores the copies in data nodes corresponding to a data storage space.

To indicate a data node in which specific data is stored, a management node stores metadata corresponding to data storage information in a memory, a solid state drive (SSD) and a hard disk (HD) and manages the metadata.

When a specific client requests certain data, the client can access the data by inquiring of a name node about a data node in which the data is stored.

Big data is usually used for analysis. When specific jobs are performed, big data are processed in parallel in data nodes to increase a data processing speed. Parallel processing results are collected and delivered to the client.

However, since a large number of data nodes are configured in the form of a big data system composed of clusters, the number of data nodes configurable per rack is limited and thus data is randomly stored in memories, SSDs and HDs. This enlarges a cluster size and increases the number of racks, decreasing a data analysis speed.

In addition, when only SSDs are used, delay is generated in reading and writing operations, wear properties are deteriorated and the number of deletions per block is limited. Accordingly, application of only SSDs is restricted.

An example of the prior art is shown m Korean publication of unexamined patent application 10-2014-0125312.

### SUMMARY OF EMBODIMENTS OF THE INVENTION

It is a purpose of the embodiments of the present invention to provide a smart storage platform apparatus and method for efficient storage and real-time, analysis of big data, which can store data in one or more of a memory, an SSD and an HDD, selected in response to frequency of execution of a specific job on the data, retrieve data stored in a distributed manner in a transformable big data storage module, divide the data into process the data blocks in parallel, analyze specific data corresponding to a job requested by a client, and display a result of the job requested by the client through a web interface or directly transmit the result to the client.

In accordance with the present concept, the above and other purposes can be accomplished by the provision of a smart storage platform apparatus for efficient storage and real-time analysis of big data, including: a transformable big data storage module 100 for storing data from among big data in a distributed manner by selecting one or more of a memory, an SSD and an HDD in response to frequency of execution of a specific job on the data; a parallel processing big data analysis module 200 for retrieving data stored in a distributed manner in the transformable big data storage module, dividing the data into blocks, processing the data blocks in parallel and analyzing specific data corresponding to a specific job requested by a client, in data analysis according to the specific job requested by the client; and a big data management API module 300 for displaying the specific data analyzed through the parallel processing big data analysis module on a screen and then transmitting the specific data to the client requesting the specific job.

As described, the present apparatus and method can store data in a distributed manner in one or more of a memory, an SSD and an HDD, selected in response to frequency of execution of a specific job, thereby enhancing storage efficiency of large-capacity big data by as much as about 70% compared to conventional systems.

In addition, the apparatus and method can retrieve data stored in a distributed manner in the transformable big data storage module, divide the data into blocks, process the data blocks in parallel and analyze specific data corresponding to a job requested by a client, thereby enhancing a big data analysis speed by as much as about 80% compared to conventional systems.

Furthermore, the apparatus and method can display a result of the job requested by the client through a web interface or directly transmit the result to the client, thereby leading an interactive real-time response type big data platform market.

### BRIEF DESCRIPTION OF THE DRAWING

The above and other objects, features, and advantages of the embodiments of the present invention will be more clearly understood from the following detailed description taken in conjunction with the accompanying drawing, in which:

FIG. 1 illustrates a configuration of a smart storage platform apparatus 1 for efficient storage and real-time analysis of big data according to an embodiment of the present invention;

FIG. 2 is a block diagram of the smart storage platform apparatus of FIG, 1 for efficient storage and real-time analysis of big data;

FIG. 3 illustrates configurations of a name controller and a data node part in a transformable big data storage module of FIG, 2;

FIG. 4 is a block diagram of the transformable big data storage module of FIG. 2;

FIG. 5 is a block diagram of a frequency extraction controller of FIG. 4;

FIG. 6 Is a block diagram of a storage controller of FIG. 4;

FIG. 7 is a block diagram of a main controller of FIG. 4;

FIG. 8 illustrates a solid state drive (SSD) 150a of the storage controller, which is configured as a storage device by connecting a plurality of flash memory chips, according to an embodiment of the present invention;

FIG. 9 illustrates an operation of the main, controller to divide data into blocks, generate multiple copies of each block and store the copies in a distributed manner according to an embodiment of the present invention;

FIG. 10 is a block diagram of a parallel processing big data analysis module of FIG. 1;

FIG, 11 is a block diagram of a big data analysis controller of FIG, 10;

FIG. 12 is a block diagram of a big data management application programming interface (API) module of FIG. 1;

FIG. 13 illustrates an operation of the big data management API module to display specific data analyzed through the parallel processing big data analysis module on a screen and then transmit the specific data to a client requesting the data according to an embodiment of the present invention;

FIG. 14 is a flowchart illustrating a smart storage platform method for efficient storage and real-time analysis of big data according to an embodiment of the present invention;

FIG. 15 illustrates a step of analyzing a read frequency of a record block, controlling the record block to be stored in one or more of a memory, an SSD and an HDD, selected in response to the read frequency and then controlling the record block to be moved to the transformable big data storage module, through a block big data analysis controller, which is included in a step of analyzing specific data corresponding to a job requested by a client, according to an embodiment of the present invention;

FIG. 16 illustrates a step of predicting and analyzing a read frequency of a record block when the record block is written and controlling the record block to be stored in one or more of a memory, an SSD and an HDD, selected in response to the read frequency, through a block write type data analysis controller, which, is included in the step of analyzing the specific data corresponding to the job requested by the client, according to an embodiment of the present invention; and

FIG. 17 illustrates a step of selecting a copy predicted to have a shortest read response time (RRT) from among copies of a record block and performing block read thereon by means of an RRT type copy block read controller, which, is included in the step of analyzing the specific data corresponding to the job requested by the client,according to an embodiment of the present in vent ion.

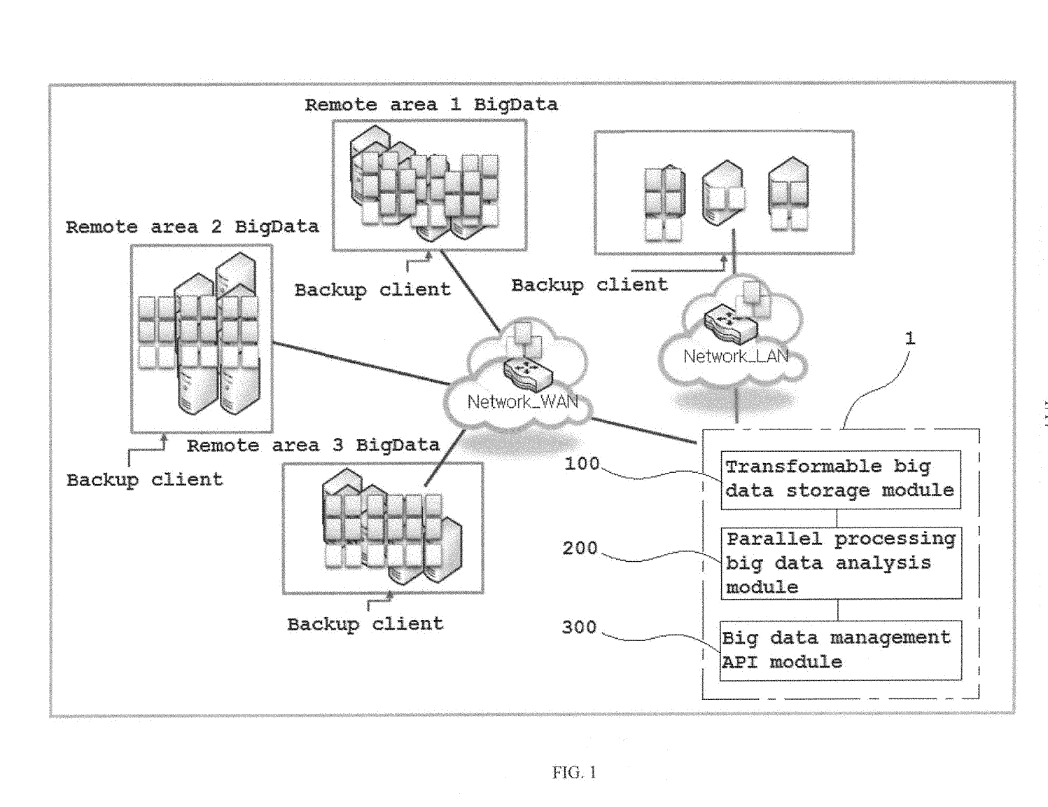

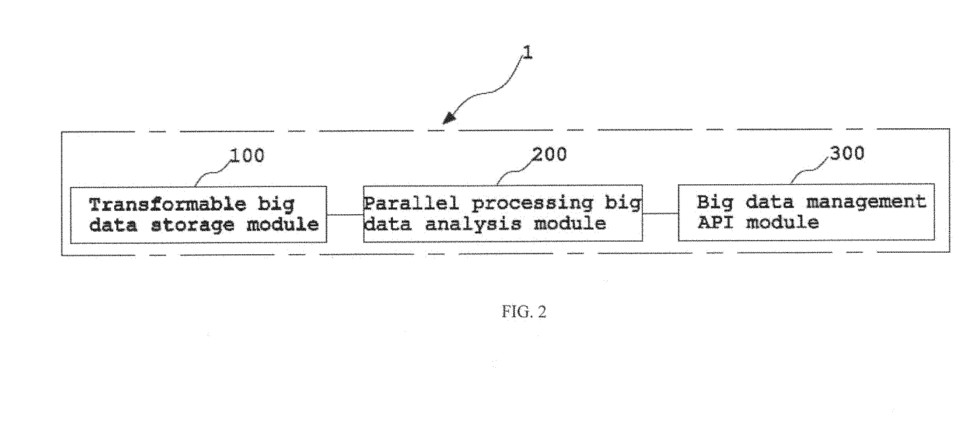

### DETAILED DESCRIPTION OF THE EMBODIMENTS OF THE INVENTION

Big data described in the present invention refers to data having a size that exceeds capacity of data collection, management and processing software.

Big data is characterized in that the size constantly changes and has a variety of volumes, generation velocities and forms of data.

A memory, SSD and HDD described in the present invention are storage devices for a data center. The SSD has a sequential read speed of 2800 to 5000 MB/s and a sequential write-speed of 1800 to 3500 MB/s. In addition, an SSD bus communication protocol may be configured and enhance storage capacity of the SSD six times or more.

Since the memory, SSD and HDD corresponding to storage devices have different block read speeds, the present invention stores data in a distributed manner in one or more of the memory, SSD and HDD, selected in response to the frequency of execution of a specific job using a block read speed difference.

Preferred embodiments of the present invention will now be described with reference to the attached drawings.

FIG, 1 illustrates a configuration of a smart storage platform apparatus 1 for efficient storage and real-time analysis of big data according to an embodiment of the present invention, and FIG, 2 is a block diagram of the smart storage platform apparatus 1 for efficient storage and real-time analysis of big data. The smart storage platform apparatus 1 includes a transformable big data storage module 100, & parallel processing big data analysis module 200, and a big data management API module 300.

A description will be given of the transformable big data storage module 100,

The transformable big data storage module 100 stores data in a distributed manner in one or more of a memory, an SSD and an HDD, selected in response to the frequency of execution of a specific job on the data.

Referring to FIG, 4, the transformable big data storage module 100 includes a name node part 110, a mapping controller 120, a data node part 130, a frequency extraction controller 140, a storage controller 150, and a main controller 160.

The name node part 110 executes functions of opening, closing and renaming files and directories and a function of a name space of the parallel processing big data analysis module.

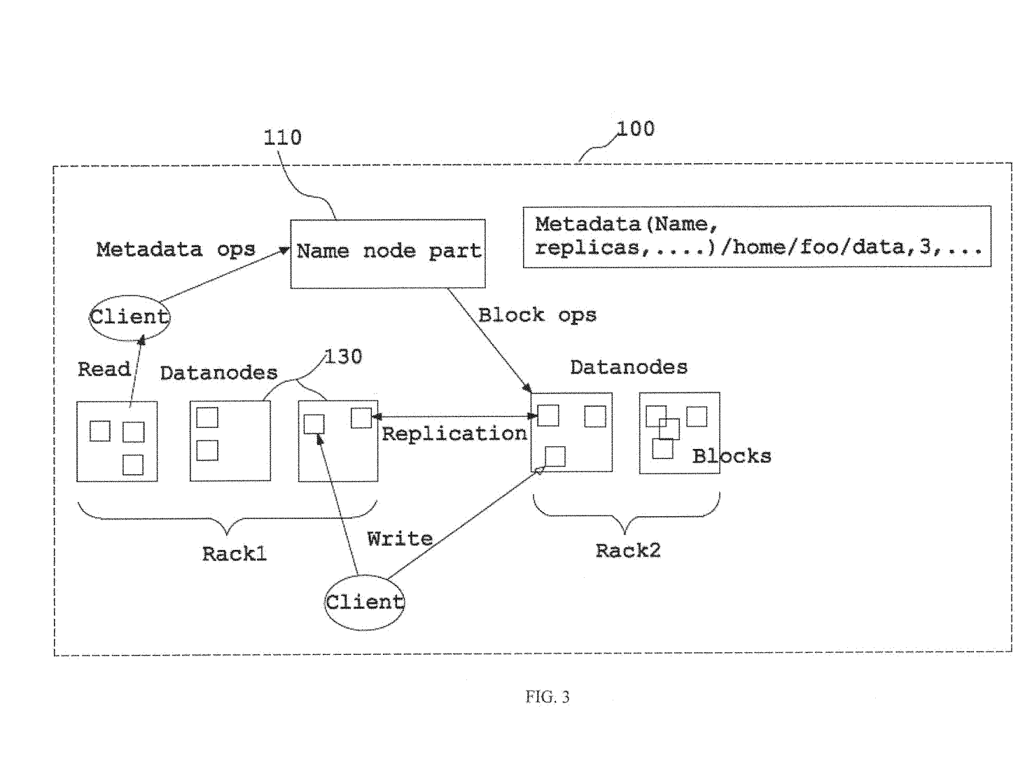

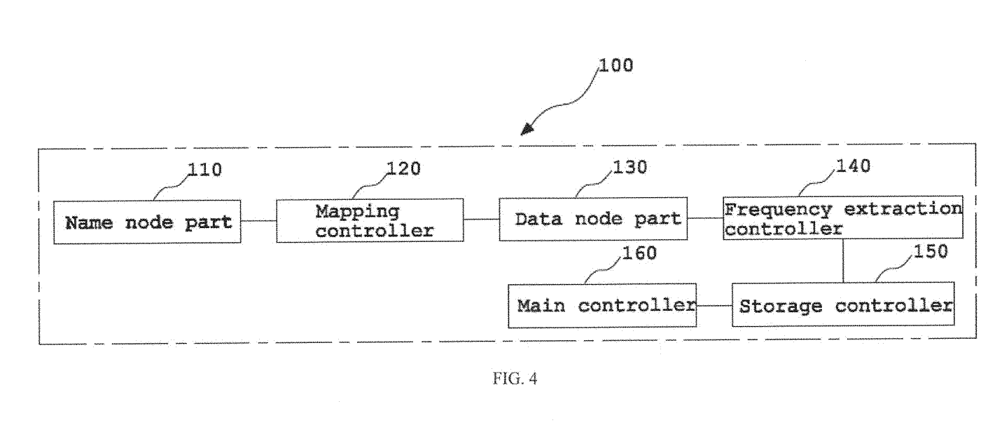

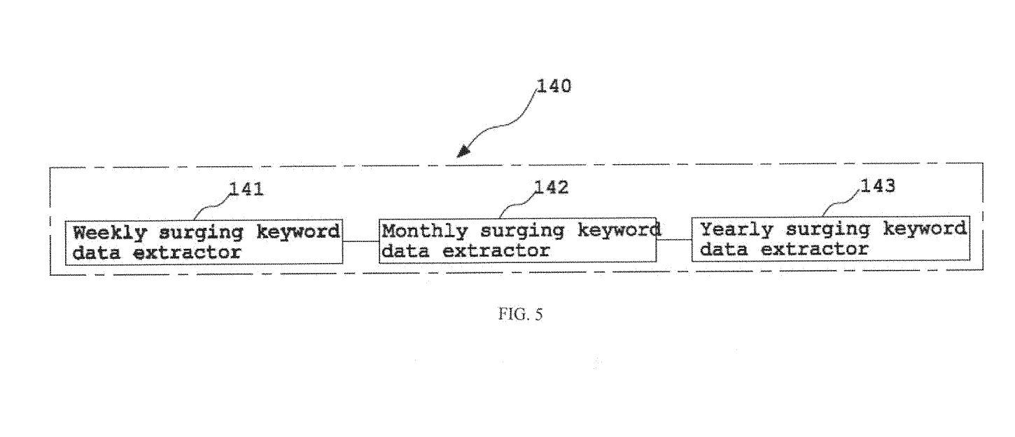

Referring to FIG. 3, the name node part 110 includes N data nodes. In addition, the name node part 110 has file names and the number of copies (for example, three) as metadata.

When a client requests a file, the name node part 110 instructs a data node having blocks corresponding to the requested file to input/output the blocks such, that the data node transmits the blocks to the client.

The mapping controller 1.20 determines and controls mapping between data nodes and blocks.

The data node part 130 executes read and write functions requested by the parallel processing big data analysis module while managing storages (memory, SSD and HDD) added to a node whenever executed.

The frequency extraction controller 140 extracts the frequency of execution of a specific job per block of the data node part through a keyword count in each time period to generate frequency data.

The frequency extraction controller 140 includes a weekly surging keyword data extractor 141, a monthly surging keyword data extractor 142, and a yearly surging keyword data extractor 143, as shown in. FIG. 5.

The weekly surging keyword data extractor 1.4 i extracts weekly surging keyword data using a HiveQL query. The monthly surging keyword data extractor 142 extracts monthly surging keyword data using a HiveQL query. The yearly surging keyword data extractor 143 extracts yearly surging keyword data using a HiveQL query.

The storage controller 150 stores data in a distributed manner in one or more of the memory, SSD and HDD, selected in response to the frequency data of the specific job, extracted by the frequency extraction controller 140.

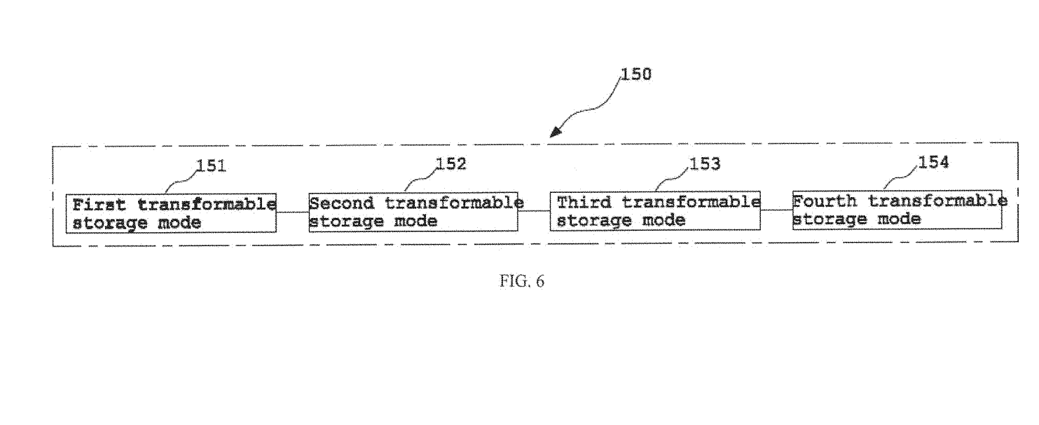

Referring to FIG. 6, the storage controller 150 includes a first transformable storage mode 151, a second transformable storage mode 152, a third-transformable storage mode 153, and a fourth transformable storage mode 154.

When three copies are set per block of the data node part, the first transformable storage mode 151 stores one copy in the memory and stores the remaining two copies in the HDD on the basis of the frequency data of the specific job, extracted through the frequency extraction controller 140.

When three copies are set per block of the data node part and the memory is full, the second transformable storage mode 152 stores one copy in the SSD and stores the remaining two copies in the HDD on the basis of the frequency data of the specific job, extracted through the frequency extraction controller 140.

When three copies are set per block of the data node part and the memory and SDD are full, the third transformable storage mode 153 stores the three copies In the HDD on the basis of the frequency data of the specific job, extracted through the frequency extraction controller, in a distributed manner.

When three copies are set per block of the data node part, the fourth transformable storage mode 154 stores a most frequently used copy in the memory, stores a second most frequently used copy in the SSD and stores a third most frequently used copy in the HDD on the basis of the frequency data of the specific job, extracted through the frequency extraction controller 140.

The SSD 150a of the storage controller according to the present invention is configured as a storage device by connecting a plurality of flash memory chips.

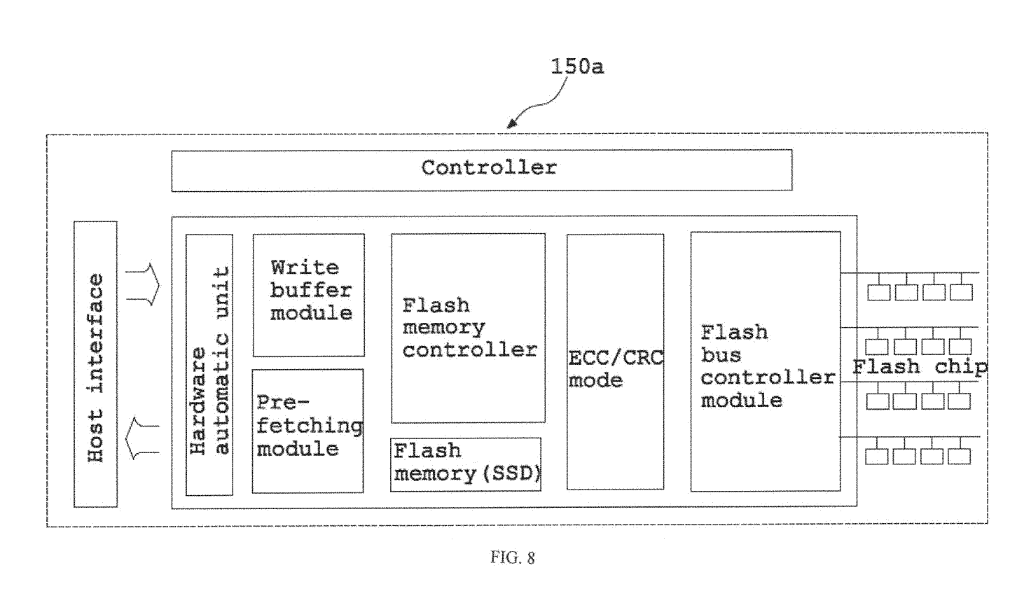

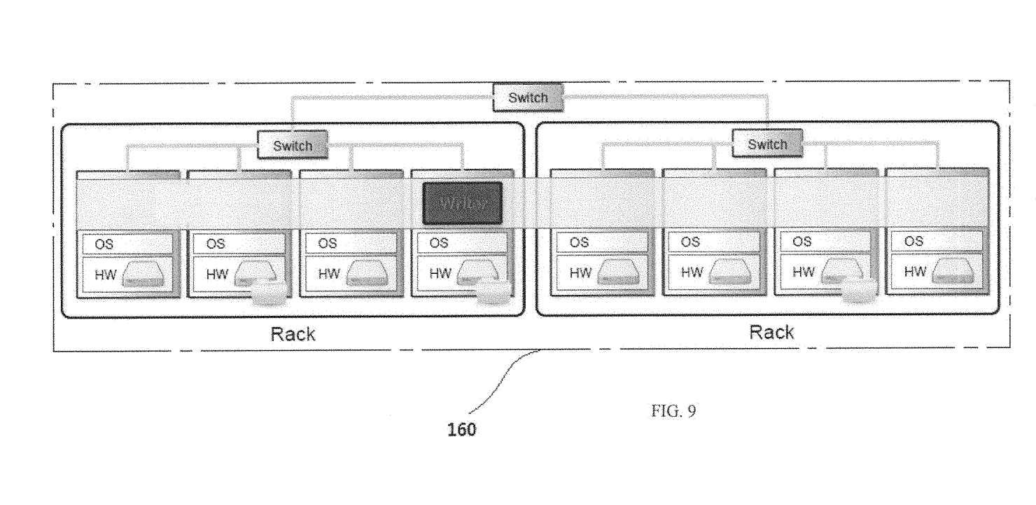

Referring to FIG. 8, the SSD 150a includes an interface connected to a PC, a flash memory controller for controlling a plurality of flash memories, a controller for controlling data exchange between the interface and the flash memory controller, and a buffer memory for reducing a processing speed difference between a bus and an SSD.

Data stored in a flash memory of the SSD is accessed in such a manner that FIFO & control is applied through the flash memory controller and an SRAM controller is accessed. The SRAM controller determines access to a RAM according to a command from a processor to access the data.

Flash memories are classified into a NOR flash memory and a NAND flash memory according to structure.

The SSD uses a NAND flash memory as a storage device using a flash semiconductor. All flash memories for use in the SSD are NAND flash memories.

One NAND flash memory chip is defined as a bank, and the bank is divided into planes. One plane is divided into a plurality of blocks, and one block is composed of a plurality of pages and spheres.

The main controller 160 controls overall operation of each device and selects and controls a data node on which a specific job will be executed.

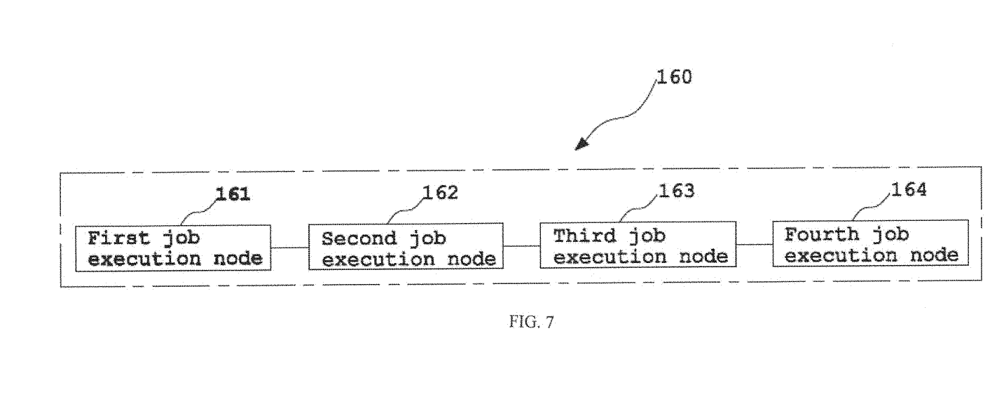

The main controller 160 is configured to selectively control one of first, second, third, and fourth job execution nodes 161, 162 163, and 164., as shown in FIG. 7.

The first job execution node 161 sets a data node having a data block on which a specific job will be executed and which is stored in the memory to a priority execution node A and controls the specific job to be executed on the priority execution node A first.

The second job execution node 162 sets a data node having a data block on which a specific job will be executed and which is stored in the SSD to a priority execution node B and controls the specific job to be executed on the priority execution node B secondly when the priority execution node A is not present or CPU usage of the specific job currently processed by the priority execution node A exceeds a reference value.

Here, the CPU usage reference value is variable according to situation, and purpose and set to 60% to 90% and, more preferably, to 80% in the presently described invention.

The third job execution node 163 sets a data node having a data block on which a specific job will be executed and which is stored in the HDD to a priority execution node C and controls the specific job to be executed on the priority execution node C thirdly when the priority execution node B is not present or CPU usage of the specific job currently processed by the priority execution node B exceeds a reference value.

The fourth job execution node 164 sets a data node having a data block on which a specific job will be executed and which Is stored in the memory to a priority execution node D and controls the specific job to be executed on the priority execution node D fourthly when the priority execution node C is not present or CPU usage of the specific job currently processed by the priority execution node C exceeds a reference value.

The main controller 160 according to the present invention has a data copy function. When a name node having metadata and a data node having copied blocks are configured, “/users/sameerp/data/part-0” file has a block copy count set to 2 and thus two copies thereof are provided per block and correspond to blocks 1 and 3, and “/users/sameerp/data/part-1” file has a block copy count set to 3 and thus three copies thereof are provided to block and correspond to blocks 2,4, and 5.

Referring to FIG. 9, the main controller 160 divides data into blocks and stores multiple copies of each block in a distributed manner.

The main controller 160 has three default replication factors. That is, one self node, one node in the same rack and one node in a different rack are present.

A description will now be given of the parallel processing big data analysis module 200.

In data analysis according to a specific job requested by a client, the parallel processing big data analysis module 200 retrieves data stored in a distributed manner In the transformable big data storage module, divides the data into pieces, processes the divided data pieces in parallel and then analyzes specific data corresponding to the job requested by the client.

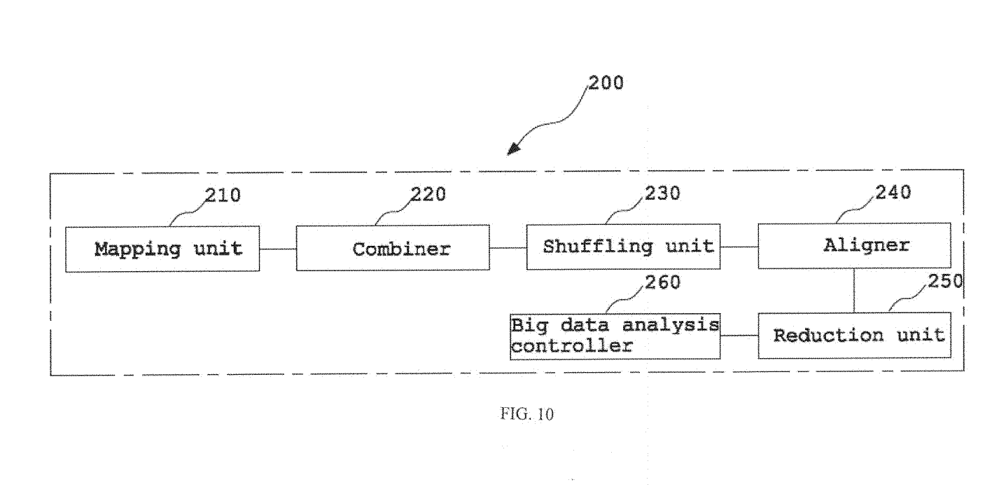

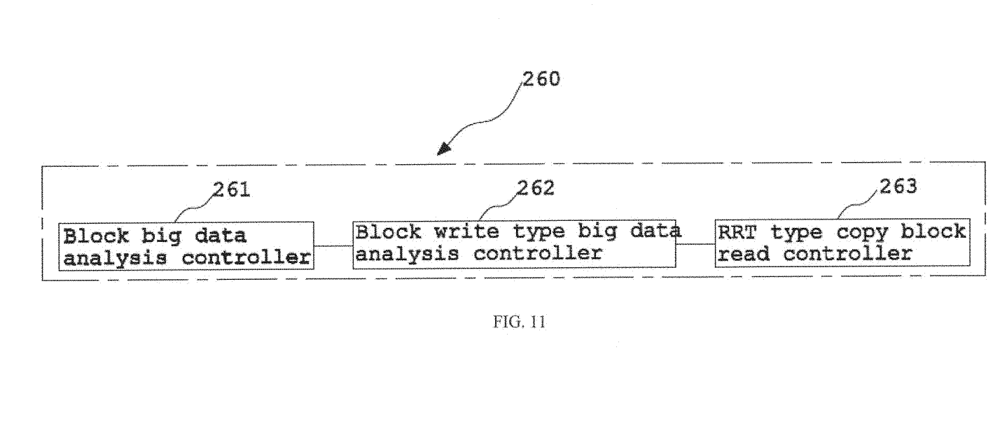

Referring to FIG. 10, the parallel processing big data analysis module 200 includes a mapping unit 210, a combiner 220, a shuffling unit 230, an aligner 240, a reduction unit 250, and a big data analysts controller 260.

The mapping unit 210 reads line feed characters of a text file line by line to make input data into desired key values. The mapping unit 210 is configured to directly code input, data Into key values that a user desires.

The mapping unit 210 inserts the key value into a result object. A plurality of mapping units 210 may be configured according to Input data size or purpose.

The combiner 220 combines the key values generated by the mapping unit 210 and transmits the combined key value as data set to a reference value to the reduction unit 250. Here, the data set to the reference value refers to a small amount of data set to the reference value.

When input data output from the mapping unit 210 is [BlueApple], [Banana], [RedApple], and [YellowApple], for example, the combiner 220 combines the input data into “key” and transmits the same to the reduction unit 250, rather than sending the four records to the reduction unit 250, thereby reducing the quantity of transmitted data.

The combiner 220 according to the present invention, combines the aforementioned input data into [Apple {BlueApple, RedApple, YellowApple}] and [Banana]. That is, the combiner 220 combines the input data into “key.”

It is very efficient to combine the unrefined four records into one key and to send only two records to the reduction unit rather than transmitting the unrefined four records to the reduction unit.

While four records are exemplified in the present embodiment, the operation of the combiner is very important since many records of key-value pairs are transmitted in actual tasks. One combiner may be configured per mapping unit.

The shuffling unit 230 transmits records contained therein through the combiner 220 to the reduction unit 250. The shuffling unit 230 includes a partitioner. The partitioner determines a reduction unit to which records output from each mapping unit will be sent.

For example, it is assumed that the following records are output from mapping units A and B through the combiner.

Mapping unit A: [Apple {BlueApple, RedApple, YellowApple}] and [Banana]

Mapping unit B: [Apple {BlueApple}], [Banana {Banana, Bluebanana}] and [Strawberry]

The records are sent to reduction units and processed therein. Here, records having the same key need to be processed in the same reduction unit in order to obtain desired data.

For example, records having a key “apple” can be output from mapping units C and D in addition to the mapping units A and B. In this case, a reduction unit to which the records will be sent is set by dividing a hash code corresponding to the key.

Specifically, the key “apple” is converted into a hash code, the hash code is divided by the number of reduction units and a reduction unit, corresponding to the remainder is set to the reduction, unit to which the records will be sent.

For example, when the key “apple” has a random hash code “145572521” and three reduction units 0, 1, and 2 are set, a reduction unit corresponding to 2, a result of 145572521/3, becomes the reduction unit to which the record “apple” will be sent.

Both the record “apple” output from the mapping unit A and the record “apple” output from the mapping unit B are sent to the reduction unit 2.

The aforementioned operation is performed by the partitioner.

The aligner 240 aligns records arriving at the reduction unit 250 on the basis of key values. The aligner 240 aligns the records arriving at the reduction unit 250 to facilitate reduction operation through the reduction unit.

The reduction unit 250 receives the records aligned through the aligner 240, collects records having the same key and sequentially processes the collected records according to a reduce function.

For example, the reduction unit 250 can output values of records with respect to “key:apple” through the following logic in the reduce function.

The output results are BlueApple, RedApple, YellowApple.
while(vales, getnext( ))
{
System.out.pritln(value,next( ).get( );
}

The reduction unit performs a customizing operation with the values of the records collected based on the key through the aforementioned process.

The reduction unit processes records input thereto into a desired format to create a result object and outputs the result object as a file.

The big data analysis controller 260 retrieves records sequentially processed through the reduction unit, analyzes read frequencies of record blocks, controls the record blocks to be stored in one or more of the memory, SSD and HDD according to the read frequencies, and then controls the record blocks to be moved to the transformable big data storage module. When a record block is written, the big data analysis controller 260 predicts and analyzes a read frequency of the record block and controls the record block to be stored in one or more of the memory, SSD and HDD selected in response to the read frequency.

Referring to FIG. 11, the big data analysis controller 260 includes a block big data analysis controller 261 and a block write type big data analysis controller 262.

The block big data analysis controller 261 controls a record block to be stored in one or more of the memory, SSD and HDD according to the read frequency of the record block, and then controls the record block to be moved to the transformable big data storage module. That is, the block big data analysis controller 261 improves the performance of the transformable big data storage module by moving a maximum number of copies of a frequently read block to the SSD, Accordingly, the number of replication factors of a file having high popularity can be increased to improve an execution time of a specific job by about 15% to about 30%.

Here, popularity refers to a maximum number of simultaneous accesses. Every data record has a popularity value and popularity is updated daily.

The read frequency f(b) of a record block b is represented by Equation 1,

f(b)=f(r₁)+f(r₂)+f(r₃) Equation 1

Storage ratios are determined according to (f1, f2, f3) for a threshold of the read frequency f(b).

TABLE 1

| | 0 ≦ f(b) < f1 | f1 ≦ f(b) < f2 | f2 ≦ f(b) < f3 | f3 ≦ r(b) |
|---|---|---|---|---|
| Memory:SSD | 1:2 | 2:3 | 1:4 | 2:4 |
| storage ratio | | | | |
| Memory:HDD | 3:1 | 2:4 | 1:2 | 0:2 |
| storage ratio | | | | |
| SSD:HDD | 2:0 | 1:3 | 3:4 | 2:3 |
| storage ratio | | | | |

The block big data analysis controller 261 according to the present invention preferentially sends a copy having high read frequency as shown in Table 1, to near one of the memory, SSD and HDD.

In addition, the block big data analysis controller 261 according to the present invention controls read frequencies of record blocks to be sent to the transformable big data storage module.

The block big data analysis controller 261 according to the present invention is configured such that a data node periodically (default 3 seconds) notifies a name node of the current state thereof.

In addition, the block big data analysis controller updates a read frequency per block at an interval of reference set time w, determines a memory:SSD storage ratio, a memory:HDD storage ratio and an SSP:HDD storage ratio according to the updated read frequency and moves copies of record blocks according to the determined ratios.

When a record block is written, the block write type big data analysis controller 262 predicts the read frequency of the record block and controls the record block to be stored in one or more of the memory, SSD and HDD, selected in response to the read frequency. Accordingly, when a record block is initially written (stored), the record block is stored in the SSD when die predicted read frequency is high, thereby improving block read performance of the transformable big data storage module.

In addition, the big data analysis controller according to the present invention includes an RRT type copy block read controller 263.

The RRT type copy block read controller 263 selects a copy, which is predicted to have a shortest read response time (RRT) from among copies of a record block, and performs block read on the selected copy.

Here, the read response time refers to a period from when one node sends a record block read request to the transformable big data storage module to when transmission of the corresponding record block is completed.

The RRT type copy block read controller 263 includes a heuristic mechanism engine. The heuristic mechanism engine is configured to simultaneously read parts of N copies, to maintain transmission of a copy having the shortest read response time and to stop transmission of the remaining copies.

The big data management API module 300 displays specific data, analyzed through the parallel processing big data analysis module and corresponding to a specific job requested by a client, on a screen and then transmits the specific data to the client. Here, the client that requests the specific job includes a demand resource (DR) manager, a power exchange and a third client.

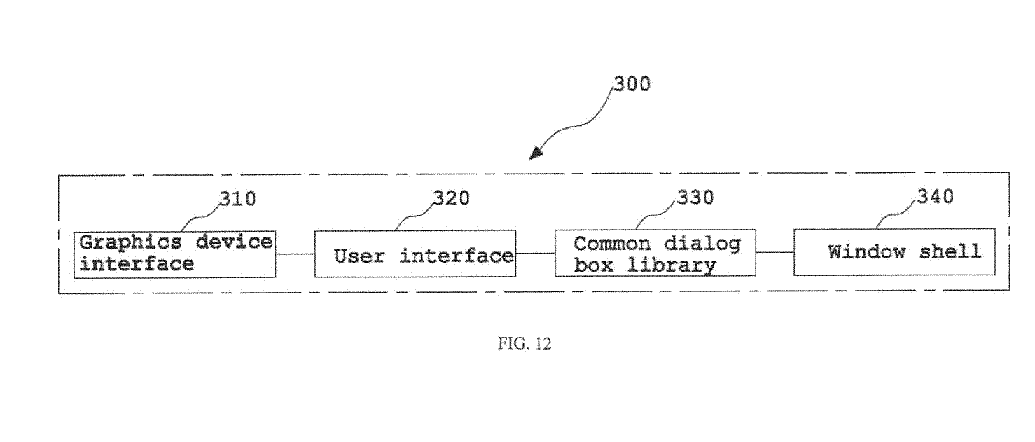

Referring to FIG. 12, the big data management API module 300 includes a graphic device interface (GDI) 310, a user interface 320, a common dialog box library 330, and a window shell 340.

The GDI 310 delivers output graphic content to a monitor, a printer or other output devices. The GDI 310 is configured as a gdi.exe in the case of 16-bit Windows and configured as a gdi32.dll in die case of 32-bit Windows in the user mode. A kernel mode GDI is supported by win.32k,sys that directly communicates with a graphics driver.

The user interface 320 generates and manages most basic control means such as windows, buttons and scroll bars, receives mouse and keyboard inputs and interoperates with a GUI of Windows. The user interface 320 is configured as a user.exe in the case of 16-bit Windows and configured as a user32.dll in the case of 32-bit Windows. Default control is configured along with common control (common control library) in a comctl32.dll after Windows XP.

The common dialog box library 330 manages and controls standard dialog boxes for file opening and storage with respect to application programs, and selection of a color and a font. The common dialog box library 330 is configured as a commdlg32.dll in the case of 16-bit Windows and is configured as a comdlg32.dll in the case of 32-bit Windows.

The window shell 340 enables an application program to access, change and control functions provided by an operating system shell. The window shell 340 is configured as a shell.dll in the case of 16-bit Windows and is configured as a shell32.dll in the case of 32-bit Windows.

A description will be given of detailed operations of a smart storage platform method for efficient storage and real-time analysis of big data.

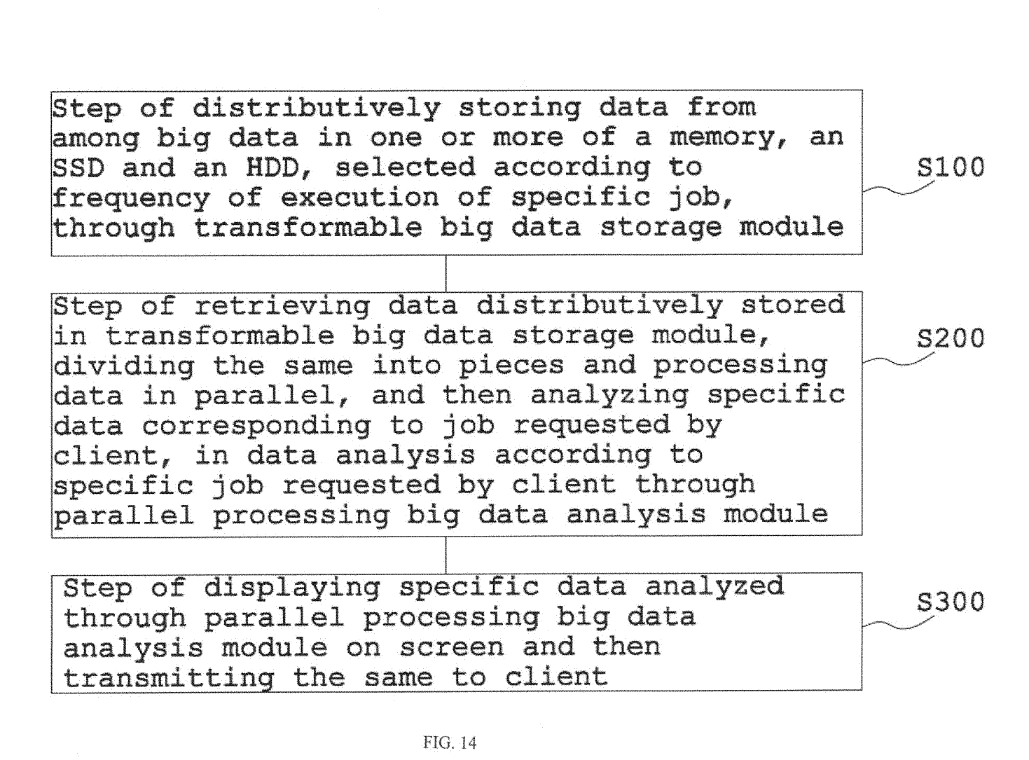

Referring to FIG. 14, data from among big data is stored in a distributed manner in one or more of a memory, an SSD and an HDD, selected according to frequency of execution of a specific job on the data, through the transformable big data storage module (S100).

Specifically, when three copies are set per block of a data node, the copies are stored in a distributed manner such that one copy is stored in the memory and the remaining two copies are stored in the HDD according to frequency data of the specific job, which is extracted through the frequency extraction controller.

When three copies are set per block of a data node and the memory is full, one copy is stored in the SSD and the remaining two copies are stored in the HDD according to the frequency data of the specific job, which is extracted through the frequency extraction controller.

When three copies are set per block of a data node and the memory and the SSD are full, the three copies are stored, in the HDD according to the frequency data of the specific job, which is extracted, through the frequency extraction controller.

When three copies are set per block of a data node, a most frequently used copy is stored in the memory, a second most frequently used copy is stored in the SSD and a third most frequently used copy is stored in the HDD according to the frequency data of the specific job, which is extracted through the frequency extraction controller.

Thereafter, in data analysis according to the specific job requested by a client through the parallel processing big data analysis module, data stored in a distributed manner in the transformable big data storage module is retrieved, divided into pieces and processed in parallel, and then specific data corresponding to the job requested by the client is analyzed (S200).

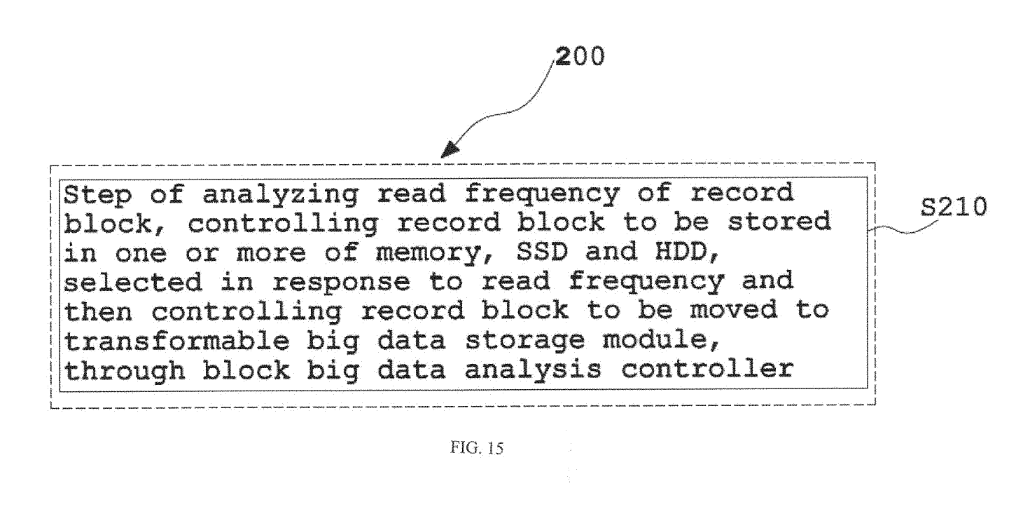

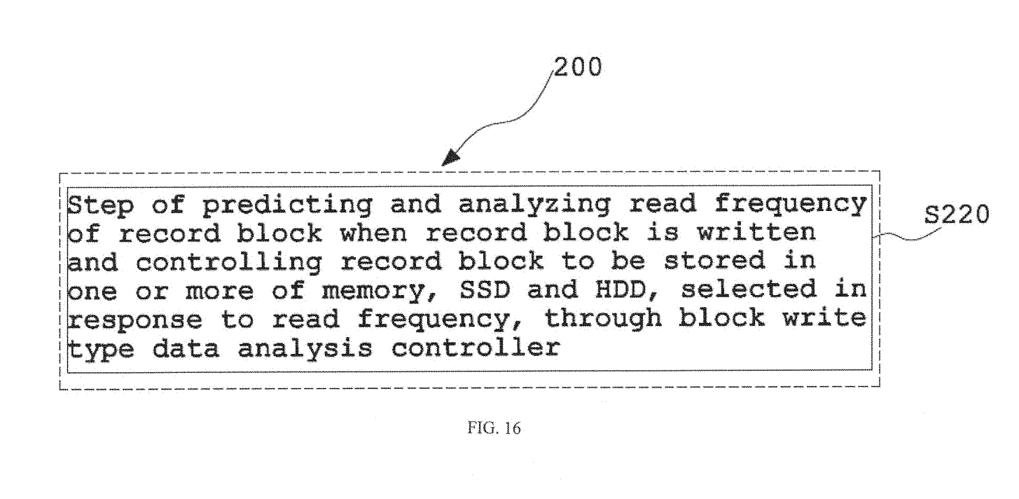

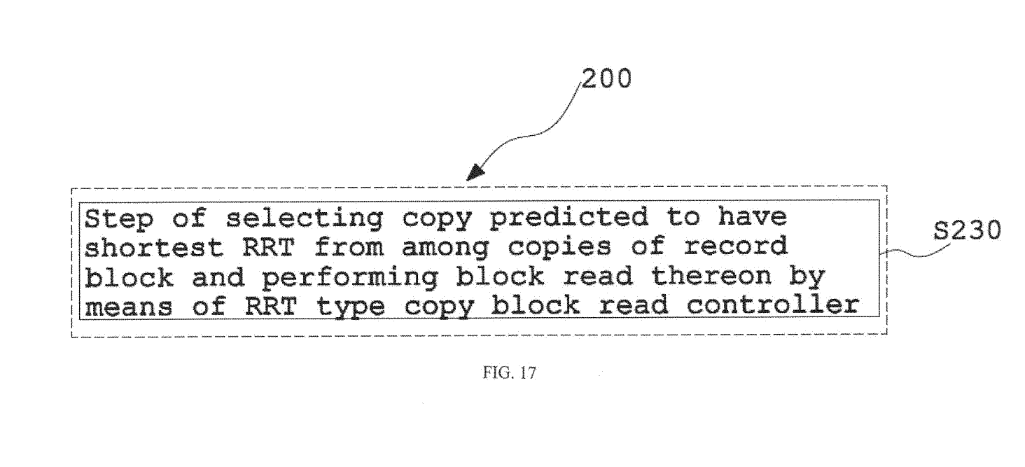

Here, analysis of the specific data corresponding to the job requested by the client is performed upon selection of one of: a step S210 of analyzing read frequency of a record block, controlling the record block to be stored in one or more of the memory, SSD and HDD, selected based on the read frequency, and controlling the record block to be moved to the transformable big data storage module, through the block big data analysis controller, as shown in FIG. 15; a step S220 of predicting and analyzing read frequency of a record block when the record block is written and controlling the record block to be stored in one or more of the memory, SSD and HDD, selected in response to the read frequency, through the block write type big data analysis controller (S220), as shown in FIG. 16; and a step S230 of selecting a copy predicted to have a shortest read response time (RRT) from among copies of a record block and performing block read thereon, through the RRY type copy block read controller (S230), as shown in FIG. 17.

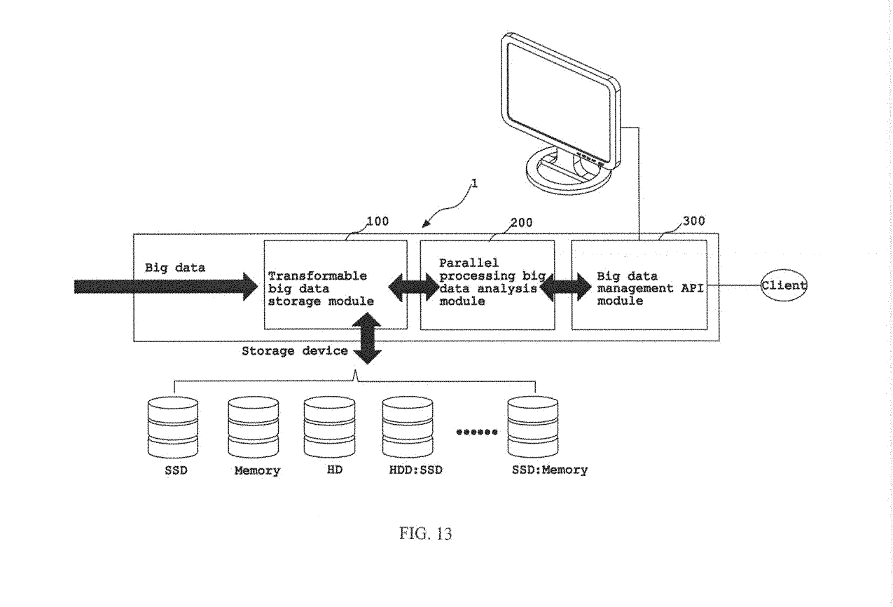

Referring to FIG. 13, the big data management API module display s the specific data analyzed through the parallel processing big data analysis module on a screen and then transmits the specific data to the client (S300).

What is claimed is:

1. A smart storage platform apparatus for efficient storage and real-time analysis of big data, the apparatus comprising:
a transformable big data storage module for storing data from among big data in a distributed manner by selecting one or more of a memory, an SSD and an HDD in response to frequency of execution of a specific job on the data;
a parallel processing big data analysis module for retrieving data stored in a distributed manner in the transformable big data storage module, dividing the data into blocks, processing the data blocks in parallel and analyzing specific data corresponding to a specific job requested by a client, in data analysis according to the specific job requested by the client; and
a big data management API module for displaying the specific data analyzed through the parallel processing big data analysts module on a screen and then transmitting the specific data to the client requesting the specific job.

2. The smart storage platform apparatus for efficient storage and real-time analysis of big data according to claim 1, wherein the transformable big data storage module comprises;
a name node part for opening, closing and renaming files and directories and executing a function of a name space of the parallel processing big data analysis module;
a mapping controller for determining and controlling mapping between data nodes and blocks;
a data node part for managing storages (a memory, an SSD and an HDD) added to a node whenever executed and executing read and write functions requested, by the parallel processing big data analysis module;
a frequency extraction controller for extracting frequency of execution of a specific job per block of the data node part through a keyword count in each time period to generate frequency data;
a storage controller for storing data in a distributed manner by selecting one or more of the memory, SSD and HDD in response to the frequency data of the specific job, extracted through the frequency extraction controller; and
a main controller for selecting and controlling a data node on which the specific job will be performed while controlling overall operation of each device.

3. The smart storage platform apparatus for efficient storage and real-time analysis of big data according to claim 2, wherein the storage controller comprises:
a first transformable storage mode for storing one copy in the memory and storing remaining two copies in the HDD according to the frequency data of the specific job, extracted through the frequency extraction controller, when three copies are set per block of the data node part;
a second transformable storage mode for storing one copy in the SSD and storing the remaining two copies in the HDD according to the frequency data of the specific job, extracted through the frequency extraction controller, when three copies are set per block of the data node part and the memory is full;
a third transformable storage mode for storing the three copies in the HDD according to the frequency data of the specific job, extracted through the frequency extraction controller, when three copies are set per block of the data node part and the memory and the SSD are full; and
a fourth transformable storage mode for storing a most frequently used copy in the memory, storing a second most frequently used copy in the SSD and storing a third most frequently used copy in the HDD according to the frequency data of the specific job, extracted through the frequency extraction controller, when three copies are set per block of the data node part.

4. The smart storage platform apparatus for efficient storage and real-time analysis of big data according to claim 2, wherein the main controller comprises:
a first job execution node for setting a data node having a data, block stored in the memory, on which a specific job will be executed, to a priority execution node A and controlling the specific job to be executed on the priority execution node A first;
a second job execution node for setting a data node having a data block stored in the SSD, on which a specific job will be executed, to a priority execution node B and controlling the specific job to be executed on the priority execution node B secondly, when the priority execution node A is not present or CPU usage of a specific job currently processed by the priority execution node A exceeds a predetermined reference value;
a third job execution node for setting a data node having a data block stored in the HDD, on which a specific job will be executed, to a priority execution node C and controlling the specific job to be executed on the priority execution node C thirdly, when the priority execution node B is not present or CPU usage of a specific job currently processed by the priority execution node B exceeds a predetermined reference value; and
a fourth job execution node for setting a data node having a data block stored in the memory, on which a specific job will be executed, to a priority execution node D and controlling the specific job to be executed on the priority execution node D fourthly, when the priority execution node C is not present or CPU usage of a specific job currently processed by the priority execution node C exceeds a predetermined reference value.

5. The smart storage platform apparatus for efficient storage and real-time analysis of big data according to claim 1, wherein the parallel processing big data analysis module comprises:
a mapping unit for reading line feed characters of a text file line by line to make input data into desired key values;
a combiner for combining the key values generated in the mapping unit so as to enable transmission of a small amount of data to a reduction unit.
a shuffling unit for transmitting records contained therein through the combiner to the reduction unit;
an aligner for aligning records arriving at the reduction unit on the basis of key values;
the reduction unit receiving the records aligned through the aligner, collecting records having the same key and sequentially processing the collected records according to a reduce function; and
a big data analysis controller for retrieving the records sequentially processed through the reduction unit, analyzing a read frequency of a record block, controlling the record block to be stored in one or more of the memory, SSD and HDD, selected in response to the read frequency, controlling the record block to be moved to the transformable big data storage module, predicting a read frequency of a record block when the record block is written, and controlling the record block to be stored in one or more of the memory, SSD and HDD, selected in response to the read frequency.

6. The smart storage platform apparatus for efficient storage and real-time analysis of big data according to claim 5, wherein the big data analysis controller comprises a block big data analysis controller for controlling the record block to be stored in one or more of the memory, SSD and HDD, selected in response to the read frequency of the record block, and then controlling the record block to be moved to the transformable big data storage module.

7. The smart storage platform apparatus for efficient storage and real-time analysis of big data according to claim 5, wherein the big data analysis controller comprises a block write type big data analysis controller for predicting and analyzing the read frequency of the record block when the record block is written, and controlling the record block to be stored in one or more of the memory, SSD and HDD, selected in response to the read frequency.

8. The smart storage platform apparatus for efficient storage and real-time analysis of big data according to claim 5, wherein the big data analysis controller comprises a read response time (RRT) type copy block read controller for selecting a copy predicted to have a shortest RRT from among copies of the record block and performing block read thereon.

9. A smart storage platform method for efficient storage and real-time analysis of big data, the method comprising;
storing data from among big data in a distributed manner by selecting one or more of a memory, an SSD and an HDD according to frequency of execution of a specific job on the data, by means of a transformable big data storage module;
retrieving data stored in a distributed manner in the transformable big data storage module, dividing the data into blocks, processing the data blocks in parallel and analyzing specific data corresponding to a specific job requested by a client, in data analysis according to the specific job requested by the client, by means of a parallel processing big data analysis module; and
displaying the specific data analyzed through the parallel processing big data analysis module on a screen and then transmitting the specific data to the client requesting the specific job, by means of a big data management API module.

10. The smart storage platform method for efficient storage and real-time analysis of big data according to claim 9, wherein the analyzing of the specific data corresponding to the job requested by the client comprises analyzing read frequency of a record block, controlling the record block to be stored in one or more of the memory, SSD and HDD, selected in response to the read frequency, and controlling the record, block to be moved to the transformable big data storage mode, by means of a block big data analysis controller.

11. The smart storage platform, method for efficient storage and real-time analysis of big data according to claim 9, wherein the analyzing of the specific data corresponding to the job requested by the client comprises predicting and analyzing the read frequency of the record block when the record block is written, and controlling the record block to be stored in one or more of the memory, SSD and HDD, selected in response to the read frequency, by means of a block write type big data analysis controller.

12. The smart storage platform method for efficient storage and real-time analysis of big data according to claim 9, wherein the analyzing of the specific data corresponding to the job requested by the client comprises selecting a copy predicted to have a shortest RRT from among copies of the record block and performing block read thereon by means of an RRT type copy block read controller.
